(19) United States
(12) Patent Application Publication
(10) Pub. No.: US 2008/0094683 A1
(43) Pub. Date: Apr. 24, 2008

(54) Light beam splitting and combining system and method thereof

(75) Inventors: Chin-Chung Chen, Padeh City (TW); Shih-Min Wu, Padeh City (TW); Chi-Neng Mo, Padeh City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD

(21) Appl. No.: 11/730,106

(22) Filed: Mar. 29, 2007

(30) Foreign Application Priority Data
Oct. 20, 2006 (TW) 95138892

(51) Int. Cl. G02F 1/07; G02F 1/00

(52) U.S. Cl. 359/263; 359/237

(57) ABSTRACT

Light beam splitting and combining system integrate some optic elements into the interfaces of two sets of prisms. Films for reducing stray color beams are coated the interfaces. Two sides of bigger prisms are faced to each other. Another side of each bigger prism is attached to the hypotenuse side of one small prism. A dichroic mirror and PBS are coated on those interfaces. Modulators are parallel to and positioned on the sides of the small prisms and a third side of one bigger prism. Such a system may be applied to a projector.

### BACKGROUND OF THE INVENTION

1. Field of the Invention

The present invention relates to a light beam splitting and combining system and method thereof, and more especially, to a light beam splitting and combining system and method thereof applied to a projector.

2. Background of the Related Art

Reflective liquid crystal display (RLCD) has gradually played an important role with the low price of liquid crystal display. Generally, RLCD is classified into on-axis and off-axis types. The on-axis RLCD, for example, four-cube type of IBM (trademark of International Business Machines Corporation), Philips (trademark of Royal Philips Electronics of the Netherlands) prism, color corner and color cube types, has difficulties in the contrast, polarized devices and colors enhancements.

FIG. 1 is a schematic diagram illustrating four-cube type for light beam splitting and combining system in accordance with one prior art. In combination of polar beam splitters 110,112,114 and X-prism 116, white light beam emitted from a light source module 12 is divided into three monochromatic light beams and then modulated by three RLCDs 120,122 and 124 for loading image data and then integrated into color image light.

FIG. 2 is a schematic diagram illustrating Philips prism type for light beam splitting and combining system in accordance with one prior art. Two total Internal Reflection (TIR) prisms 210, 212, waveguide polarizing beam splitter (WPBS) 214, RLCDs 220,222 and 224 are used to constitute a light beam splitting and combining system.

FIG. 3 is a schematic diagram illustrating a color cube type for a light beam splitting and combining system in accordance with one prior art. Four polarizing beam splitters (PBSs) 310, 312, 314, 316, three color selectors 330, 332, 334, and RLCDs 320, 322, 324 are combined to form light beam splitting and combining system.

The prior light beam splitting and combining system aforementioned, there is stray light in those monochromatic light beams. The existence of stray light has influences on the brightness of dark field and contrast. Furthermore, the many amounts of elements and complex design of optic path increase the difficulties in assembly, alignment and requirement of high accuracy.

### SUMMARY OF THE INVENTION

The present invention provides a light beam splitting and combining system and method. Some optical elements are directly formed on the interfaces of other optical devices to enhance the high accuracy of alignment.

The present invention further provides a light beam splitting and combining system and method. One or more coatings utilized may disperse other stray light under the transmission of the required light, so as to prevent the stray light from entering into the system and reduce heat generation.

The present invention further provides a light beam splitting and combining system and method. Two sets of prisms of different dimensions are utilized associated with surface treatment to reduce the amount of optical devices in the system.

Accordingly, one embodiment of the present invention provides a light beam splitting and combining system and method integrating some optical elements, such as dichroic mirror and PBS, into the interfaces of two sets of prisms. Films for reducing stray color beams are coated the interfaces. Two sides of bigger prisms are opposite attached to each other. Another side of each bigger prism is attached to the hypotenuse side of one small prism. A dichroic mirror and PBS are coated on those interfaces. Modulators are parallel to and positioned on the sides of the small prisms and the third side of one bigger prism. Such a system may be applied to a projector.

Accordingly, a method of splitting and combining light beams is provided therein. A first light beam of a first polarity is provided with a first, a second and a third monochromatic light beams of a first polarity. The first light beam is divided into the first monochromatic light beam and a second light beam in which the second light beam includes the second and the third monochromatic light beams of the first polarity. The first monochromatic light beam is modulated into the first monochromatic light of a second polarity different from the first polarity. The second light beam is polarized to generate the second monochromatic light beam of the second polarity and the third color light beam of the first polarity. The second monochromatic light beam of the second polarity is also modulated to generate a third light beam which includes the second monochromatic light beam of the first polarity. The third monochromatic light beam of the first polarity is modulated to generate a fourth light beam which includes the third monochromatic light beam of the second polarity. The third light beam, fourth light beam and modulated first monochromatic light beam are polarized to generate a fifth light beam which includes the first, second and third monochromatic light beams all of the second polarity.

### BRIEF DESCRIPTION OF THE DRAWINGS

FIG. 1 is a schematic diagram illustrating four-cube type for light beam splitting and combining system in accordance with one prior art;

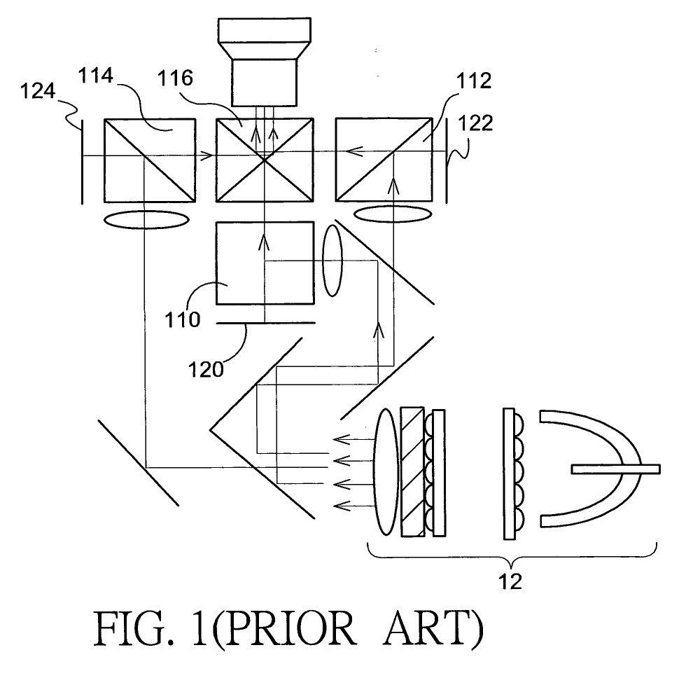

FIG. 2 is a schematic diagram illustrating Philip prism type for light beam splitting and combining system in accordance with one prior art;

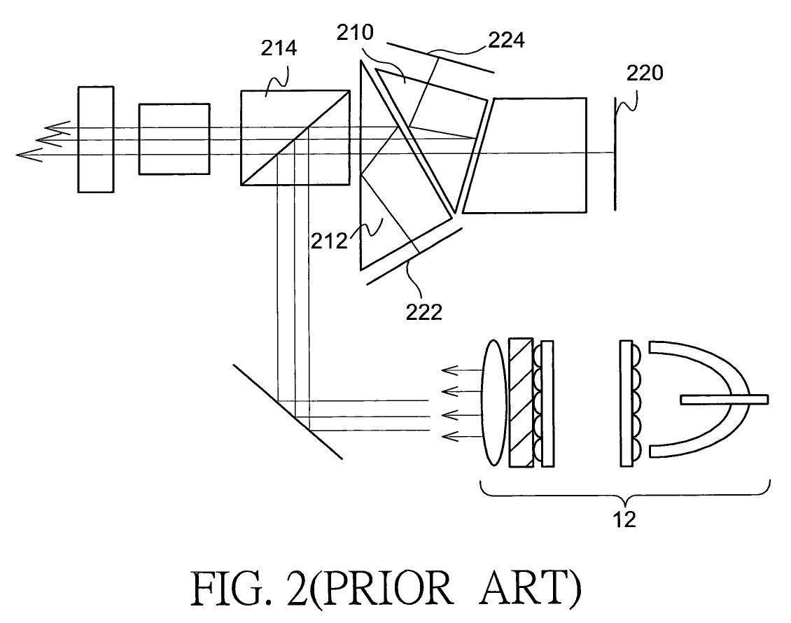

FIG. 3 is a schematic diagram illustrating color cube type for light beam splitting and combining system in accordance with one prior art;

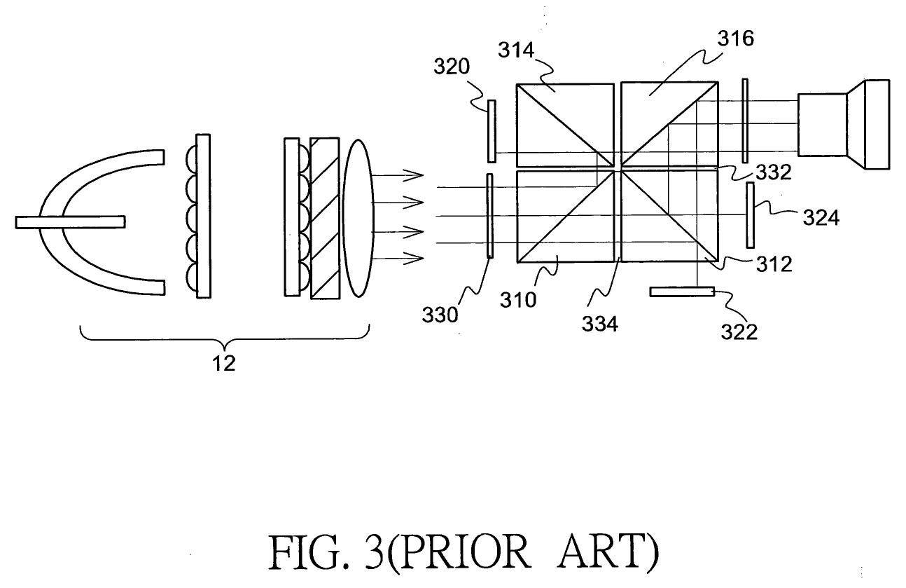

FIG. 4A is a schematic diagram illustrating a light beam splitting and combining system in accordance with one embodiment of the present invention;

FIG. 4B is a schematic diagram illustrating a light beam splitting and combining system in accordance with another one embodiment of the present invention;

FIG. 5 is a schematic diagram illustrating a light beam splitting and combining system in accordance with another embodiment of the present invention; and

FIG. 6 is a schematic diagram illustrating the transmission of coating used in one embodiment of the present invention.

### DETAILED DESCRIPTION OF THE INVENTION

The features of the present invention are illustrated in association with the following figures. It is noted that the optic paths are drew for clarification. Those who know the knowledge in the field should understand all the paths are performed according to fundamental optical knowledge.

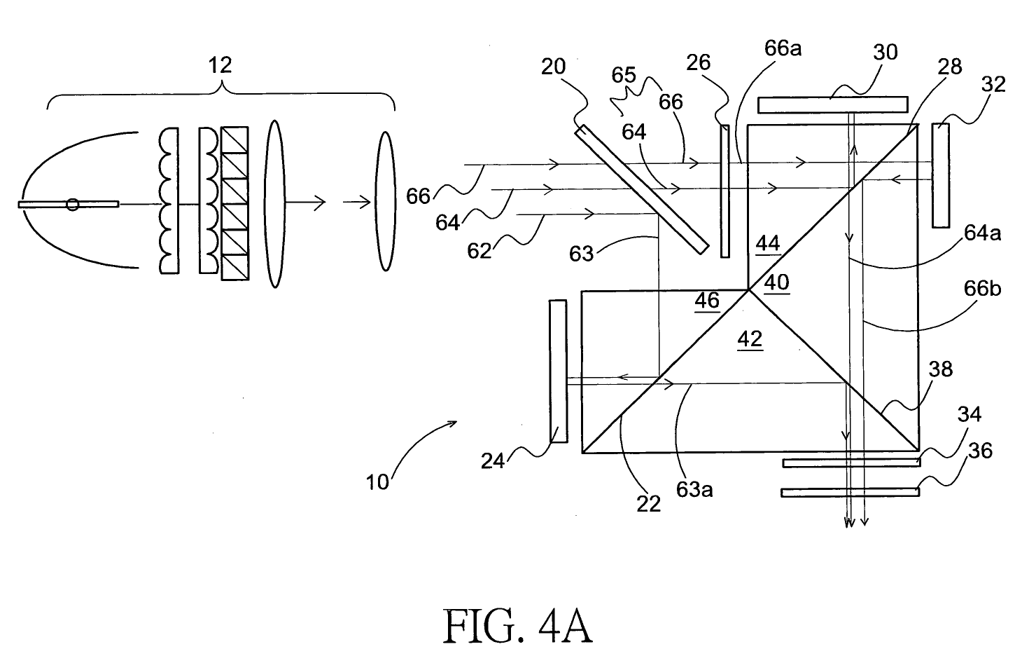

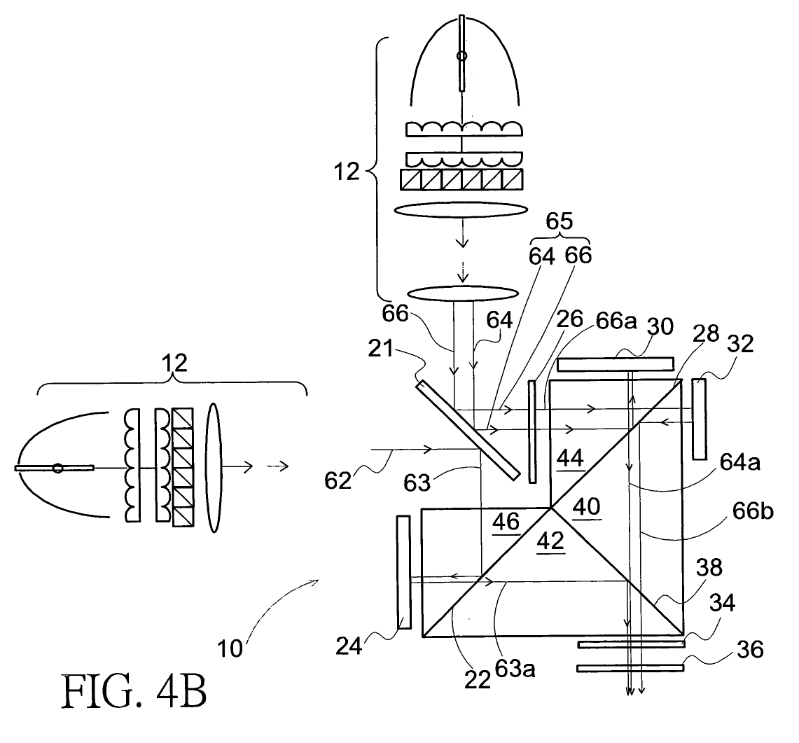

FIG. 4A is a schematic diagram illustrating a light beam splitting and combining system in accordance with one embodiment of the present invention. A light beam splitting and combining system 10 mainly includes a first prism 40 and a second prism 42 in an identical dimension, and a third prism 44 and a fourth prism 46 in another identical dimension. Each prism aforementioned has a first side, a second side and a third side. In one embodiment, two polar beam splitters 28 and 22 are respectively formed on the respective one sides of the first prism 40 and second prism 42 by a coating method and then respectively attached to the first sides of the third prism 44 and the fourth prism 46. Furthermore, the first prism 40 and the second prism 42 are attached to each other with the respective second sides by a method of, such as UV adhesive, after a dichroic mirror 38 is formed respectively on one second side of the first prism 40 or the second prism 42.

Next, a modulator 32 is positioned on the third side of the first prism 40 and a color selector 34 is positioned on the third side of the second prism 42. Similarly, another modulator 30 and a color selector 26 are respectively positioned on the second and third sides of the third prism 44. Furthermore, another modulator 24 is positioned on the third side of the fourth prism 46. A dichroic mirror 20 (in FIG. 4A) or a double mirror 21 (in FIG. 4B) is positioned between the third prism 44 and fourth prism 46, such as the position of angle bisector, which is aligned with the dichroic mirror 38.

Accordingly, one of features of the present invention is to utilize some optical thin film devices directly formed on the interfaces of the prisms, so as to simplify the alignment step for the light beam splitting and combining system 10 and meet the accuracy requirement. Furthermore, the optical thin film devices formed by the interface treatment may occupy less space so as to be applied to portable equipment. Furthermore, the arrangement of the optical devices in the embodiment of the present invention provides a simplified an optic path to reduce the problem of the stray light and enhance the color contrast. One exemplary optic path is illustrated as follows.

Referring to FIG. 4A and FIG. 4B continuously, a light source module 12 outputs different monochromatic light beams 62, 64 and 66 with same polarity, such as S polarity. The monochromatic light beams 62, 64 and 66 (viewed as the first light beam) firstly penetrates through a dichroic mirror 20 or double mirror 21 and then are divided into a reflected light beam 63 and a transmission light beam 65 (viewed as the second light beam). One of the reflecting light beams 63 and transmission light beam 65 may include two color light beams. In the embodiment, the transmission light beam 65 is provided with the monochromatic light beams 64 and 66, and the reflected light beam 63 includes the monochromatic light beam 62. Next, the reflected light beam 63 is reflected by a polar beam splitter 22 (to change the optic path of the reflected light beam 63) and then incident to a modulator 24 to generate a monochromatic light 63a with loaded image data. Of the different polarity from the reflected light beam 63 of one, the monochromatic light 63a may transmit through the PBS 22 and then be reflected by the dichroic mirror 38. It is noted that, when the double mirror 21 is utilized, the monochromatic light beams 62, 64 and 66 may be generated in different optic paths by a plurality of light source module and incident to the light splitting and combining system from the two sides of the double mirror 21.

On the other hand, still shown in FIG. 4A and FIG. 4B, the transmission light beam 65 including the monochromatic light beams 64 and 66 penetrates through the color selector 26 to convert the monochromatic light beam 66 into the monochromatic light beam 66a of different polarity and keep the monochromatic light beam 64 of the primary polarity. Of the different polarities, the monochromatic light beam 66a is separated from the monochromatic light beam 64 by the polar beam splitter 28. In the embodiment, the monochromatic light beam 66a penetrates through the polar beam splitter 28 and is modulated by another modulator 32 to be converted into a monochromatic light beam 66b (viewed as the third light beam) with loaded data. It is noted that the polarities of the monochromatic light beam 66b and the monochromatic light beam 66 are identical. On the other hand, the monochromatic light beam 64 of the primary polarity is reflected by the polar beam splitter 28 and then incident to a modulator 30 to generate the monochromatic light beam 64a (viewed as the fourth light beam) with loaded image data. With the different directions of polarity and different colors, the monochromatic light beam 64a may be transmitted through the polar beam splitter 28 and the dichroic mirror 38 and then parallel to the monochromatic light 63a reflected by the dichroic mirror 38. On the other hand, the modulated monochromatic light beam 66b penetrates through the polar beam splitter 28 (to change the optic path thereof) and then transmits the dichroic mirror 38 to align with the monochromatic light beam 64a and monochromatic light 63a. It is noted that the polarity of the monochromatic light beam 66b is different from the ones of the monochromatic light beam 64a and the monochromatic light 63a.

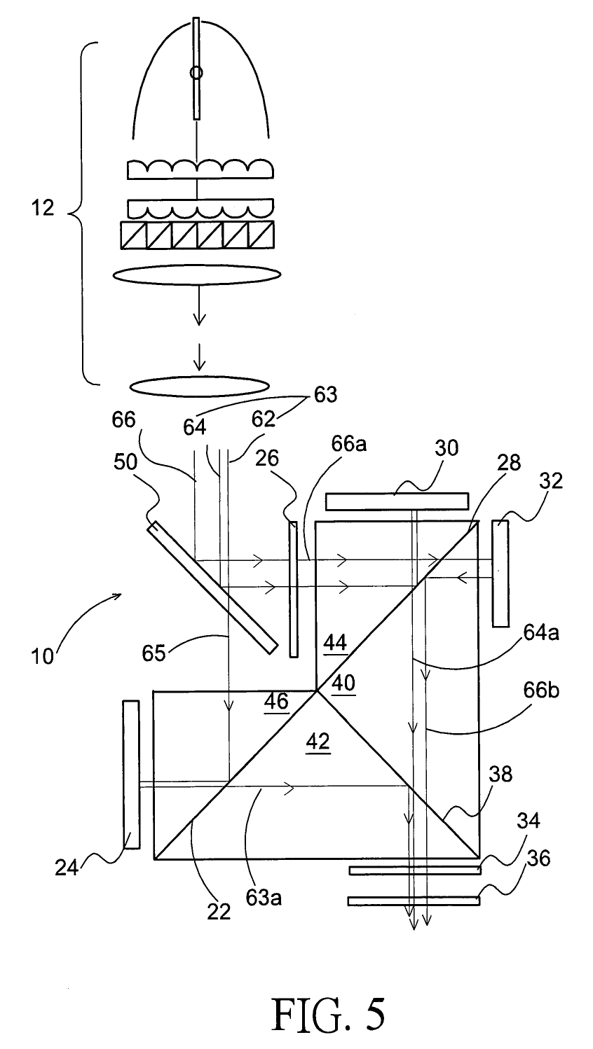

Finally, shown in FIG. 4A and FIG. 4B, a color selector 34 may convert the polarities of the monochromatic light beam 64a and monochromatic light 63a into the same polarity as the monochromatic light beam 66b, as well as reversely, to become the color image data for a lens module (not shown on the drawing) through a polarizer 36. In one embodiment, the monochromatic light beam 62 is a green light beam of S polarity, monochromatic light beam 64 is a blue light beam of S polarity and the monochromatic light beam 66 is a red light beam of S polarity. For the associated modulators, the modulator 24 is a green reflective liquid crystal display (RLCD), the modulator 30 is a blue RLCD and the modulator 32 is a red RLCD. Next, the dichroic mirrors 20 and 38 may permit of the reflection of green light and the transmission of red and blue light. Furthermore, the PBS 22 is same as the polar beam splitter 28. Alternatively, the dichroic mirror 21 may be changed for the light source in the different incident direction. Shown in FIG. 5, the dichroic mirror 50 may permit of the transmission of green light and the reflection of red and blue light. Other optical devices in FIG. 5 are same as the ones in FIG. 4A and FIG. 4B. For light beam, the reflected light beam 63 includes the monochromatic light beams 64 and 66, and the transmission light beam 65 includes the monochromatic light beam 62.

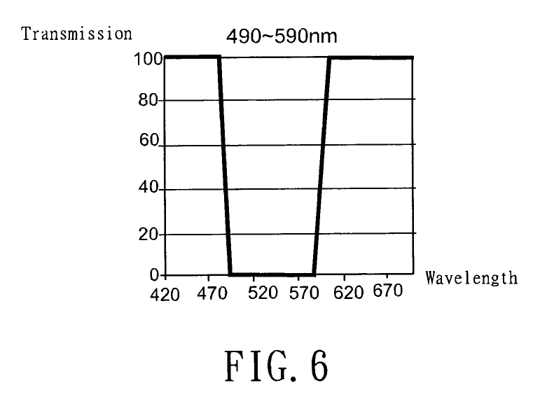

It is noted that one of features of the present invention may reduce heat generated by optic system. Shown on FIG. 6, in one embodiment, the coating film for the dichroic mirror is provided with the low transmission in the wavelength range of 490 to 590 nm. It is advantageous that yellow light beam with the wavelength of 570 nm may be outside of the light beam splitting and combining system 10 for reducing heat generated by the entrance of yellow light beam to prevent the leakage of dark field. Thus, a whole optic path is simplified with the use of the dichroic mirror associated with PBS. Furthermore, optic thin film devices are utilized for reducing alignment step, improving the accuracy of the system and reducing the manufacture cost. Furthermore, the yellow light beam is reflected away to reduce heat effect on the dark field.

Accordingly, one embodiment of the present invention provides a light beam splitting and combining system for a projector. Each prism is provided with a first side, a second side and a third side. A first dichroic mirror is attached between the second side of a second prism and the second side of a first prism. A first polar beam splitter is attached between the first side of the first prism and the first side of a third prism. A second polar beam splitter is attached between the first side of the second prism and the first side of a fourth prism. A first color selector is adjacent to the third side of the third prism. A second color selector is adjacent to the third side of the second prism. A first modulator is positioned on the third side of the first prism and opposite parallel to the first color selector. A second modulator is adjacent to the second side of the third prism and opposite parallel to the second color selector. A third modulator is adjacent to the third side of the fourth prism. A second dichroic mirror is positioned between the third side of the third prism and the second side of the fourth prism.

Accordingly, one embodiment of the present invention provides a method of splitting and combining light beams. A first light beam includes a first, a second and a third monochromatic light beams of a first polarity. The first light beam is divided into the first monochromatic light beam and a second light beam. The second light beam includes the second and the third monochromatic light beams of the first polarity. The first monochromatic light beam is modulated into the first monochromatic light; of a second polarity different from the second polarity. The second light beam is polarized to generate the second monochromatic light beam of the second polarity and the third color light beam of the first polarity. The second monochromatic light beam of the second polarity is modulated to generate a third light beam which includes the monochromatic light beam of the first polarity. The third monochromatic light beam of the first polarity is modulated to generate a fourth light beam which includes the third monochromatic light beam of the second polarity. The third light beam, fourth light beam and modulated first monochromatic light beam are polarized to generate a fifth light beam which includes the first, second and third monochromatic light beams all of the second polarity.

Although the present invention has been explained in relation to its preferred embodiment, it is to be understood that other modifications and variation can be made without departing the spirit and scope of the invention as hereafter claimed.

What is claimed is:

1. A light beam splitting and combining system, applied to a projector, comprising:
a first dichroic mirror;
a first prism with a first side, a second side and a third side;
a second prism with a first side, a second side and a third side, wherein the first dichroic mirror is attached between the second side of the second prism and the second side of the first prism;
a first polar beam splitter;
a third prism with a first side, a second side and a third side, wherein the first polar beam splitter is attached between the first side of the first prism and the first side of the third prism;
a second polar beam splitter;
a fourth prism with a first side, a second side and a third side, wherein the second polar beam splitter is attached between the first side of the second prism and the first side of the fourth prism;
a first color selector adjacent to the third side of the third prism;
a second color selector adjacent to the third side of the second prism;
a first modulator positioned on the third side of the first prism and opposite parallel to the first color selector;
a second modulator adjacent to the second side of the third prism and opposite parallel to the second color selector;
a third modulator adjacent to the third side of the fourth prism; and
a second dichroic mirror positioned between the third side of the third prism and the second side of the fourth prism. [symbol] reflective light beam transmission through the second side of the fourth prism.

9. A light beam splitting and combining system, applied to a projector, comprising:
a dichroic mirror;
a first prism with a first side, a second side and a third side;
a second prism with a first side, a second side and a third side, wherein the dichroic mirror is attached between the second side of the second prism and the second side of the first prism;
a first polar beam splitter;
a third prism with a first side, a second side and a third side, wherein the first polar beam splitter is attached between the first side of the first prism and the first side of the third prism;
a second polar beam splitter;
a fourth prism with a first side, a second side and a third side, wherein the second polar beam splitter is attached between the first side of the second prism and the first side of the fourth prism;
a first color selector adjacent to the third side of the third prism;
a second color selector adjacent to the third side of the second prism;
a first modulator positioned on the third side of the first prism and opposite parallel to the first color selector;
a second modulator adjacent to the second side of the third prism and opposite parallel to the second color selector;
a third modulator adjacent to the third side of the fourth prism; and
a double mirror positioned between the third side of the third prism and the second side of the fourth prism.

10. A light beam splitting and combining system according to claim 9, further comprising a plurality of light source modules providing a plurality of monochromatic light beams incident from two sides of the double mirror onto the double mirror.

11. A light beam splitting and combining system according to claim 10, wherein the double mirror reflects a portion of the monochromatic light beams into the third prism and the other portion of the monochromatic light beams into the fourth prism.

12. A light beam splitting and combining system according to claim 11, wherein the second polar beam splitter directs the portion of the portion of monochromatic light beams that penetrates through the second side of the fourth prism into the third modulator.

13. A light beam splitting and combining system according to claim 11, wherein the first modulator reflects and modulates the portion of monochromatic light beams that penetrates through the third prism.

14. A light beam splitting and combining system according to claim 9, wherein each of the first, second and third modulators is reflective liquid crystal display.

15. A light beam splitting and combining system according to claim 9, wherein a coating of each of the polar beam splitters has a reflective wavelength in the range of 490 to 590 nm.
